(19) United States
(12) Patent Application Publication
(10) Pub. No.: US 2019/0251583 A1
(43) Pub. Date: Aug. 15, 2019

(54) MARKETING METHOD AND SYSTEM FOR INTERNET INSURANCE PRODUCTS

(71) Applicant: ZhongAn Information Technology Service Co., Ltd., Shenzhen (CN)

(72) Inventors: Kun MEI, Shenzhen (CN); Heng WANG, Shenzhen (CN); Gufei SUN, Shenzhen (CN)

(21) Appl. No.: 16/392,424

(22) Filed: Apr. 23, 2019

Related U.S. Application Data
(63) Continuation of application No. PCT/CN2019/074418, filed on Feb. 1, 2019.

(30) Foreign Application Priority Data
Feb. 2, 2018 (CN) 201810105304.2

(51) Int. Cl. G06Q 30/02; G06F 17/15; G06Q 40/08; G06F 16/901

(52) U.S. Cl. CPC G06Q 30/0204; G06F 17/15; H04L 67/02; G06F 16/9024; G06Q 40/08

(57) ABSTRACT

The present application discloses a marketing method and system for Internet insurance products. The method includes: constructing a broker social network graph according to first insurance related data, the broker social network graph including a plurality of first sub-graphs; performing a community division on each first sub-graph of the plurality of first sub-graphs to obtain a first community structure; calculating respective node network indicators of the first sub-graph and at least one layer of community in the first community structure to obtain a plurality of node network indicators; and analyzing the plurality of node network indicators and marketing Internet insurance products based on an analysis result. The embodiments of the present application enable the marketing of Internet insurance products to be carried out effectively and improve the probability of success in Internet insurance marketing.

### CROSS-REFERENCE TO RELATED APPLICATIONS

The present application is a continuation of international application No. PCT/CN2019/074418 filed on Feb. 1, 2019, which claims priority to Chinese patent application No. 201810105304.2, filed on Feb. 2, 2018. Both applications are incorporated herein in their entireties by reference.

### TECHNICAL FIELD

The present application relates to the field of social network technologies, and more particularly to a marketing method and system for Internet insurance products.

### BACKGROUND

A social network refers to a network of relationships between individuals and individuals, whose theoretical basis is derived from the Six Degrees of Separation and the Rule of 150. In a social network, users and users, users and subjects, users and activities may form networks of relationships, and thus forming massive data based on a graph structure. One of the main directions of the analysis of a social network is graph data mining for relation graphs.

Communities reflects localized characteristics of individuals' behaviors in a network and their correlation with each other. The research on the communities in the network plays a vital role in understanding the structure and function of the entire network, helping to analyze and predict the interaction between elements of the entire network.

Insurance marketing is a series of activities which take insurance this special commodity as an object, take consumer's demand for this special commodity as a guidance, focus on meeting consumer's demand for transferring risks and transfer insurance commodities to consumers by means of various marketing methods to achieve a long-term business objective of an insurance company. The marketing cost of traditional offline insurance marketing mode is high, so with the continuous development of the Internet technology, and the traditional insurance companies and the Internet giants have deployed the Internet insurance. However, due to the low level of trust between people, the probability of success of the insurance in the Internet marketing is low.

How to use social network technology to market Internet insurance products effectively to increase the probability of success in Internet insurance marketing, there is no a technical solution proposed in the industry.

### SUMMARY

In order to solve the problems of the prior art, embodiments of the present application provide a marketing method and system for Internet insurance products, which enable the marketing of Internet insurance products to be carried out effectively and improve the probability of success in Internet insurance marketing.

According to a first aspect, the embodiments of the present application provide a marketing method for Internet insurance products, which includes: constructing a broker social network graph according to first insurance related data, the broker social network graph including a plurality of first sub-graphs; performing a community division on each first sub-graph of the plurality of first sub-graphs to obtain a first community structure; calculating respective node network indicators of the first sub-graph and at least one layer of community in the first community structure to obtain a plurality of node network indicators; and analyzing the plurality of node network indicators and marketing Internet insurance products based on an analysis result.

In some embodiments of the present application, the constructing a broker social network graph according to first insurance related data includes: constructing the broker social network graph by using a weakly connected graph according to the first insurance related data. A node of the broker social network graph represents a broker, and an edge of the broker social network graph represents a broker social relationship.

In some embodiments of the present application, the performing a community division on each first sub-graph of the plurality of first sub-graphs includes: performing a community division on the first sub-graph by using a community division algorithm to generate a plurality of first sub-communities; performing a community division on each of the plurality of first sub-communities by reusing the community division algorithm to generate a plurality of second sub-communities for the plurality of first sub-communities; and determining whether the number of the plurality of second sub-communities is equal to the number of the plurality of first sub-communities, and if so, stopping performing a community division, and if not, continuing performing a community division on the plurality of second sub-communities.

In some embodiments of the present application, the community division algorithm is a GN algorithm.

In some embodiments of the present application, the analyzing the plurality of node network indicators and marketing Internet insurance products based on an analysis result includes: sorting node network indicators of the first sub-graph according to a plurality of indicator categories, and determining a plurality of first nodes in which node network indicators of each of the plurality of indicator categories are top ranked; sorting node network indicators of at least one layer of community in the first community structure according to the plurality of indicator categories, and determining a plurality of second nodes in which node network indicators of each of the plurality of indicator categories are top ranked; determining a node in a union of the plurality of first nodes and the plurality of second nodes as a key node; and marketing the Internet insurance products based on the key node. The plurality of indicator categories include a degree centrality, a closeness centrality, a betweenness centrality and a pagerank.

In some embodiments of the present application, the method of the first aspect further includes: constructing a broker product sharing network graph according to second insurance related data, the broker product sharing network graph including a plurality of second sub-graphs; performing a community division on the plurality of second sub-graphs respectively to obtain a plurality of second community structures; and calculating respective KPI indicators of the plurality of second sub-graphs and at least one layer of community in each of the plurality of second community structures to obtain a plurality of KPI indicators. The analyzing the plurality of node network indicators and marketing Internet insurance products based on an analysis result includes: analyzing the plurality of node network indicators and the plurality of KPI indicators, and marketing the Internet insurance products based on an analysis result.

According to a second aspect, the embodiments of the present application provide a marketing method for Internet insurance products, which includes: constructing a broker product sharing network graph according to insurance related data, the broker product sharing network graph including a plurality of second sub-graphs; performing a community division on the plurality of second sub-graphs respectively to obtain a plurality of second community structures; calculating respective KPI indicators of the plurality of second sub-graphs and at least one layer of community in each of the plurality of second community structures to obtain a plurality of KPI indicators; and analyzing the plurality of KPI indicators and marketing Internet insurance products based on an analysis result.

In some embodiments of the present application, the constructing a broker product sharing network graph according to insurance related data includes: constructing the broker product sharing network graph by using a weakly connected graph according to the insurance related data. A node of the broker product sharing network graph represents a broker or a customer, and an edge of the broker product sharing network graph represents a broker marketing an insurance product to a customer.

In some embodiments of the present application, the performing a community division on the plurality of second sub-graphs respectively includes: performing a community division on each of the plurality of second sub-graphs by using a community division algorithm to generate a plurality of third sub-communities; performing a community division on each of the plurality of third sub-communities by reusing the community division algorithm to generate a plurality of fourth sub-communities for the plurality of third sub-communities; and determining whether the number of the plurality of fourth sub-communities is equal to the number of the plurality of third sub-communities, and if so, stopping performing a community division, and if not, continuing performing a community division on the plurality of fourth sub-communities.

In some embodiments of the present application, each of the plurality of KPI indicators includes the number of brokers, times for sharing products, a distribution of hot-selling products and active time periods for sharing. The analyzing the plurality of KPI indicators and marketing Internet insurance products based on an analysis result includes: determining a key sub-graph in the plurality of second sub-graphs and a key community in the plurality of second community structures based on the number of brokers and the times for sharing products, wherein each of the number of brokers in the key sub-graph and that in the key community exceeds a preset threshold, while each of times for sharing products exceeds a preset value; determining respective hot-selling products of the key sub-graph and the key community based on the distribution of hot-selling products to obtain a plurality of hot-selling products; and marketing a similar product of the plurality of hot-selling products in the key sub-graph and the key community respectively based on an active time period for sharing of each of the plurality of hot-selling products.

According to a third aspect, the embodiments of the present application provide a marketing system for Internet insurance products, which includes: a network constructing module, configured to construct a broker social network graph according to first insurance related data, the broker social network graph including a plurality of first sub-graphs; a community dividing module, configured to perform a community division on each first sub-graph of the plurality of first sub-graphs to obtain a first community structure; a network indicator calculating module, configured to calculate respective node network indicators of the first sub-graph and at least one layer of community in the first community structure to obtain a plurality of node network indicators; and an insurance marketing module, configured to analyze the plurality of node network indicators and market Internet insurance products based on an analysis result.

In some embodiments of the present application, the network constructing module is configured to construct the broker social network graph by using a weakly connected graph according to the first insurance related data. A node of the broker social network graph represents a broker, and an edge of the broker social network graph represents a broker social relationship.

In some embodiments of the present application, the community dividing module includes: a first dividing sub-module, configured to perform a community division on the first sub-graph by using a community division algorithm to generate a plurality of first sub-communities; a second dividing sub-module, configured to perform a community division on each of the plurality of first sub-communities by reusing the community division algorithm to generate a plurality of second sub-communities for the plurality of first sub-communities; and a controlling sub-module, configured to determine whether the number of the plurality of second sub-communities is equal to the number of the plurality of first sub-communities, and if so, stopping performing a community division, and if not, continuing performing a community division on the plurality of second sub-communities.

In some embodiments of the present application, the insurance marketing module includes: a first sorting sub-module, configured to sort node network indicators of the first sub-graph according to a plurality of indicator categories, and determine a plurality of first nodes in which node network indicators of each of the plurality of indicator categories are top ranked; a second sorting sub-module, configured to sort node network indicators of at least one layer of community in the first community structure according to the plurality of indicator categories, and determine a plurality of second nodes in which node network indicators of each of the plurality of indicator categories are top ranked; a determining sub-module, configured to determine a node in a union of the plurality of first nodes and the plurality of second nodes as a key node; and a first marketing sub-module, configured to market the Internet insurance products based on the key node. The plurality of indicator categories include a degree centrality, a closeness centrality, a betweenness centrality and a pagerank.

In some embodiments of the present application, the network constructing module is further configured to construct a broker product sharing network graph according to second insurance related data, the broker product sharing network graph including a plurality of second sub-graphs. The community dividing module is further configured to perform a community division on the plurality of second sub-graphs respectively to obtain a plurality of second community structures. The system further includes a KPI indicator calculating module, configured to calculate respective KPI indicators of the plurality of second sub-graphs and at least one layer of community in each of the plurality of second community structures to obtain a plurality of KPI indicators. The insurance marketing module is configured to analyze the plurality of node network indicators and the plurality of KPI indicators, and market the Internet insurance products based on an analysis result.

According to a fourth aspect, the embodiments of the present application provide a marketing system for Internet insurance products, which includes: a network constructing module, configured to construct a broker product sharing network graph according to insurance related data, the broker product sharing network graph including a plurality of second sub-graphs; a community dividing module, configured to perform a community division on the plurality of second sub-graphs respectively to obtain a plurality of second community structures; a KPI indicator calculating module, configured to calculate respective KPI indicators of the plurality of second sub-graphs and at least one layer of community in each of the plurality of second community structures to obtain a plurality of KPI indicators; and an insurance marketing module, configured to analyze the plurality of KPI indicators and market Internet insurance products based on an analysis result.

In some embodiments of the present application, the network constructing module is configured to construct the broker product sharing network graph by using a weakly connected graph according to the insurance related data. A node of the broker product sharing network graph represents a broker or a customer, and an edge of the broker product sharing network graph represents a broker marketing an insurance product to a customer.

In some embodiments of the present application, the community dividing module includes: a first dividing sub-module, configured to perform a community division on each of the plurality of second sub-graphs by using a community division algorithm to generate a plurality of third sub-communities; a second dividing sub-module, configured to perform a community division on each of the plurality of third sub-communities by reusing the community division algorithm to generate a plurality of fourth sub-communities for the plurality of third sub-communities; and a controlling sub-module, configured to determine whether the number of the plurality of fourth sub-communities is equal to the number of the plurality of third sub-communities, and if so, stopping performing a community division, and if not, continuing performing a community division on the plurality of fourth sub-communities.

In some embodiments of the present application, each of the plurality of KPI indicators includes the number of brokers, times for sharing products, a distribution of hot-selling products and active time periods for sharing. The insurance marketing module includes: a first determining sub-module, configured to determine a key sub-graph in the plurality of second sub-graphs and a key community in the plurality of second community structures based on the number of brokers and the times for sharing products, wherein each of the number of brokers in the key sub-graph and that in the key community exceeds a preset threshold, while each of times for sharing products exceeds a preset value; a second determining sub-module, configured to determine respective hot-selling products of the key sub-graph and the key community based on the distribution of hot-selling products to obtain a plurality of hot-selling products; and a second marketing sub-module, configured to market a similar product of the plurality of hot-selling products in the key sub-graph and the key community respectively based on an active time period for sharing of each of the plurality of hot-selling products.

According to a fifth aspect, the embodiments of the present application provide a computer readable storage medium, which includes computer instructions stored thereon. When the computer instructions are executed by a processor, the processor is induced to perform a marketing method for Internet insurance products according to the first aspect or the second aspect.

According to a sixth aspect, the embodiments of the present application provide a computer device including a processor and a storage device. The storage device includes computer instructions stored thereon. When the computer instructions are executed by the processor, the processor is induced to perform a marketing method for Internet insurance products according to the first aspect or second aspect.

The embodiments of the present application provide a marketing method and system for Internet insurance products. By constructing a broker social network graph or a product sharing network graph according to insurance related data and using a community division algorithm, a group of insurance brokers with higher activity and importance can be mined effectively, and the probability of success in Internet insurance marketing can be improved.

### BRIEF DESCRIPTION OF DRAWINGS

In order to illustrate technical solutions in the embodiments of the present application more clearly, a brief introduction of the accompanying drawings used in descriptions of the embodiments will be given below. Obviously, the accompanying drawings described below are only a part of the embodiments of the present application, and for those skilled in the art, other accompanying drawings can be obtained according to these accompanying drawings without creative efforts.

FIG. 1 is a schematic flowchart illustrating a marketing method for Internet insurance products according to an embodiment of the present application.

FIG. 2 is a schematic flowchart illustrating performing a community division on a first sub-graph according to an embodiment of the present application.

FIG. 3 is a schematic flowchart illustrating a marketing method for Internet insurance products according to another embodiment of the present application.

FIG. 4 is a schematic flowchart illustrating performing a community division on a plurality of second sub-graphs respectively according to an embodiment of the present application.

FIG. 5 is a schematic flowchart illustrating a marketing method for Internet insurance products according to another embodiment of the present application.

FIG. 6 is a schematic diagram illustrating a community division result of a broker product sharing network graph according to an embodiment of the present application.

FIG. 7 is a schematic structural diagram illustrating a marketing system for Internet insurance products according to an embodiment of the present application.

FIG. 8 is a schematic structural diagram illustrating a marketing system for Internet insurance products according to another embodiment of the present application.

FIG. 9 is a block diagram illustrating a computer device for marketing Internet insurance products according to an exemplary embodiment of the present application.

### DETAILED DESCRIPTION

In order to make purposes, technical solutions and advantages of the present application clearer, a clear and complete description of technical solutions of the embodiments of the present application will be given below, in combination with the accompanying drawings in the embodiments of the present application. Obviously, the embodiments described below are a part, but not all, of the embodiments of the present application. All of other embodiments, obtained by those skilled in the art based on the embodiments of the present application without creative efforts, shall fall within the protection scope of the present application.

The embodiments of the present application provide a marketing method for Internet insurance products, which is applied to the marketing of insurance products, enables the marketing of Internet insurance products to be carried out effectively, and improves the probability of success in Internet insurance marketing. The Internet insurance products may be relatively simple products such as accident insurance, car insurance, return freight insurance, or may be complicated products such as life insurance, and the specific Internet insurance products are not limited by the embodiments of the present application. In addition, the method provided by the embodiments of the present application may further be applied to the marketing of other products through the Internet, and the products may be physical products or virtual products. The virtual products such as electronic books, virtual props, and the like, and the specific application scenarios are not limited by the present application.

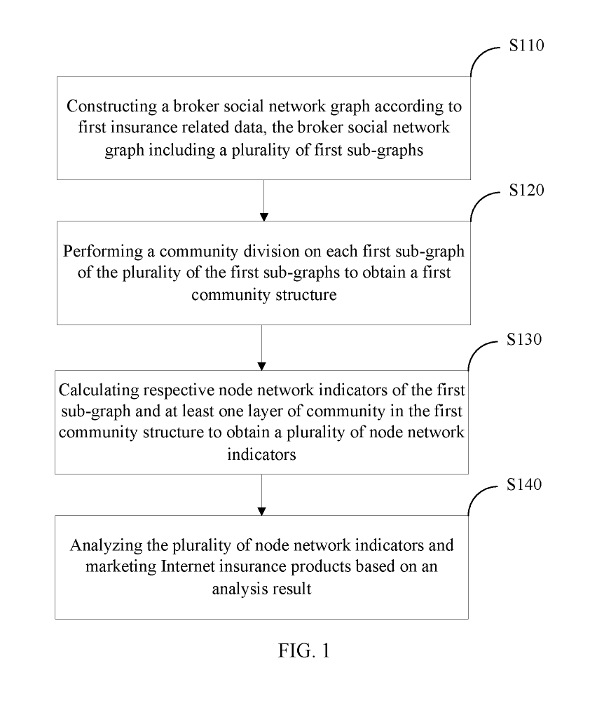

FIG. 1 is a schematic flowchart illustrating a marketing method for Internet insurance products according to an embodiment of the present application. The executive subject of the method may be a variety of devices such as a desktop computer, a personal computer, a mobile terminal and a server. As shown in FIG. 1, the method includes the following steps.

S110: constructing a broker social network graph according to first insurance related data, the broker social network graph including a plurality of first sub-graphs.

Specifically, the first insurance related data may include an insurance broker basic information table, insurance broker social data, and the like. The broker social network graph may show the social relationship of insurance brokers. Each first sub-graph may be interrelated or may be independent of each other, which is not limited by the present application.

S120: performing a community division on each first sub-graph of the plurality of first sub-graphs to obtain a first community structure.

Each first sub-graph corresponds to a first community structure, each first community structure may include at least one layer of community, and each layer of community may include at least one sub-community.

S130: calculating respective node network indicators of the first sub-graph and at least one layer of community in the first community structure to obtain a plurality of node network indicators.

Specifically, the first sub-graph may include a plurality of nodes, and if there is an association between two nodes, the two nodes may be connected through a connection line. A node in the first sub-graph represents a broker, and an edge (i.e., the connection line) in the first sub-graph may represent a broker social relationship.

S140: analyzing the plurality of node network indicators and marketing Internet insurance products based on an analysis result.

Specifically, by calculating a node network indicator of each node in the first sub-graph, brokers corresponding to nodes with higher node network indicators may be selected as key brokers to market the insurance products, thereby improving the probability of success in insurance marketing.

Alternatively, when the first community structure includes multi-layer of communities, key brokers may be selected by calculating the node network indicators of each sub-community in a certain layer of community of the first community structure. For example, when a layer of community includes five sub-communities, the node network indicator of each node in the five sub-communities may be calculated separately, and then key brokers corresponding to each sub-community are selected to market the insurance products. Of course, the node network indicators of each sub-community of each layer of community in the multi-layer of communities may also be calculated, and then key brokers corresponding to each sub-community are selected.

The number of the key brokers may be one or more, and may be set specifically according to an actual requirement.

The embodiments of the present application provide a marketing method for Internet insurance products. By constructing a broker social network graph according to insurance related data and using a community division algorithm, a group of insurance brokers with higher activity and importance can be mined effectively, and the probability of success in Internet insurance marketing can be improved.

According to an embodiment of the present application, S110 may include: constructing the broker social network graph by using a weakly connected graph according to the first insurance related data.

Specifically, the concept of the weakly connected graph is to replace all directed edges of a directed graph with undirected edges, and a resulting graph is the basis of an original graph. If a base graph of a directed graph is a connected graph, the directed graph is a weakly connected graph.

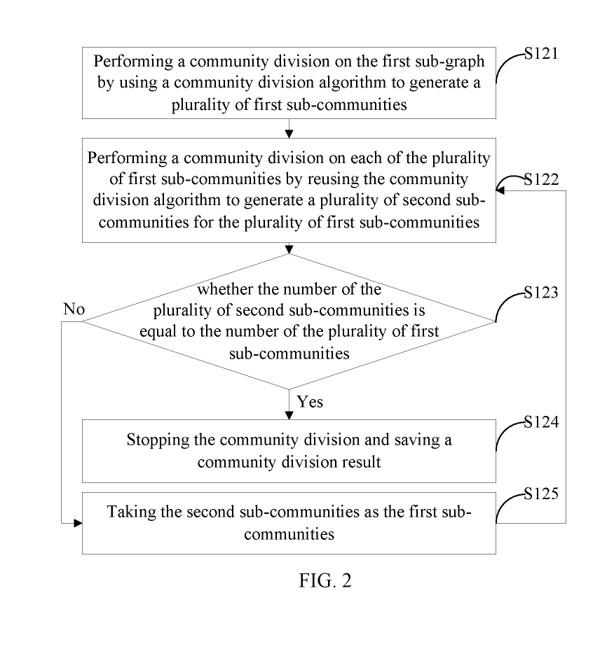

According to an embodiment of the present application, as shown in FIG. 2, S120 includes the following steps.

S121: performing a community division on the first sub-graph by using a community division algorithm to generate a plurality of first sub-communities.

Specifically, the plurality of first sub-communities may be a first layer of community in the first community structure, that is, the first layer of community includes the plurality of first sub-communities.

S122: performing a community division on each of the plurality of first sub-communities by reusing the community division algorithm to generate a plurality of second sub-communities for the plurality of first sub-communities.

Specifically, the plurality of second sub-communities may be a second layer of community in the first community structure, that is, the second layer of community includes the plurality of second sub-communities. Each first sub-community may be divided into one or more second sub-communities, and second sub-communities corresponding to all first sub-communities may constitute the plurality of second sub-communities of the second layer of community.

Wherein, the number of nodes in the first sub-graph, the number of nodes of all first sub-communities in the first layer of community, and the number of nodes of all second sub-communities in the second layer of community are equal.

S123: determining whether the number of the plurality of second sub-communities is equal to the number of the plurality of first sub-communities, and if so, executing S124, and if not, executing S125.

S124: stopping the community division and saving a community division result.

S125: taking the second sub-communities as the first sub-communities, and continuing executing S122, and that is, continuing performing a community division on the plurality of second sub-communities.

Specifically, each second sub-community in the second layer of community may be divided continually until no more sub-communities can be divided. That is, when the number of all the second sub-communities in the second layer of community is the same as the number of all the first sub-communities in the first layer of community, the division is stopped, otherwise the division is continued.

According to an embodiment of the present application, a community discovery algorithm may include a Q-Modularity algorithm for calculating the degree of network modularity and an Edge Betweenness algorithm for calculating the edge tightness of the network.

The community division in this embodiment is to calculate the Edge Betweenness indicator by using a Girvan and Newman (GN) algorithm, the principle of which is that in a network, the number of shortest paths through edges within the community is relatively small, while the number of shortest paths through edges between communities is relatively large.

The steps of the GN algorithm are described in the following:

a. Calculating the edge betweenness of each edge in a network including n nodes. Specifically, searching the shortest path for each pair of nodes to obtain a shortest path set S with the value of n*(n−1)/2, wherein the edge betweenness of a connected edge is the number of the shortest path including the connected edge in the S set.

b. Deleting the edge with the largest edge betweenness.

c. Recalculating edge betweennesses of edges remaining in the network.

d. Repeating steps b and c until any vertex in the network is a community.

e. Calculating community modularity indicators and returning the best community division result, wherein the modularity is configured to measure advantages and disadvantages of a community division result.

In addition to the above, S120 may be implemented in other ways, and the specific community division manners are not limited by the embodiments of the present application.

According to an embodiment of the present application, a node network indictor may include a plurality of indictor categories, and the plurality of indictor categories may include various network indictors such as a degree centrality, a closeness centrality, a betweenness centrality, and a pagerank.

With regard to degree centrality:

The calculation of the degree centrality is based on the degree itself and refers to the number of other nodes to which a node directly connected in the network, and the larger the number of other nodes, the greater the degree. A degree of a node vᵢ, denoted as Kᵢ, refers to the number of nodes directly connected to vᵢ, and is the most basic static feature of the node. In a directed network, the degree of a node is divided into the indegree and the outdegree according to the difference in the directions of connected edges. The normalization degree centrality indicator of the node vᵢ is defined as:

$$D C ( i ) = \frac{{K}_{i}}{n - 1} , {k}_{i} = {\sum }_{i} {a}_{ij} ;$$

wherein, aᵢⱼ is an element of an i-th row and a j-th column in a neighboring matrix A of a network, n is the number of nodes of the network, and the denominator n−1 is a possible maximum degree of the node.

With regard to closeness centrality:

The calculation of the closeness centrality is based on the concept of the shortest path, focusing on expressing the degree of difficulty of a node to other nodes, that is, accessibility. The smaller an average distance between one node and other nodes in the network, the greater the closeness centrality of the node. For a connected network with n nodes, the closeness centrality of the node vᵢ may be defined as:

$$CC ( i ) = \frac{n - 1}{{\sum }_{j \neq i} {d}_{ij}} ;$$

wherein, dᵢⱼ is a distance from the node vᵢ to a node vⱼ in the network, and n is the number of nodes in the network.

With regard to betweenness centrality:

The betweenness centrality refers to a ratio of the number of the shortest paths of nodes pair passing through a certain node in the network to a total number of the shortest paths of nodes pair, which represents a control effect of one node on other nodes, that is, a global control capability. The normalized betweenness centrality indicator of the node vᵢ is defined as:

$${BC}^{′} ( i ) = \frac{2}{( n - 1 ) ( n - 2 )} \sum \frac{{g}_{st}^{′}}{{g}_{st}} ;$$

wherein, gₛₜ is the number of all shortest paths from the node vₛ to the node vₜ, g′ₛₜ is the number of shortest paths passing through the node vᵢ in the gₛₜ shortest paths from the node vₛ to the node vₜ, and n is the number of nodes in the network.

With regard to pagerank:

The pagerank of a node refers to a weighted sum of importance scores of all nodes that point to it. A PageRank algorithm in the web page sorting field may be adopted to assign the same PR value to each node, at an initial time. Then the iteration is performed, and in each step, a current PR value of each node is divided equally into all nodes to which it points. A new PR value of each node is a sum of PR values it has obtained, and thus a PR value of the node vᵢ obtained at time t is:

$${PR}_{i} ( t ) = {\sum }_{j = 1}^{n} {a}_{ji} \frac{{PR}_{j} ( t - 1 )}{{k}_{j}^{out}} ;$$

wherein, aⱼᵢ represents the number of paths that the node vⱼ points to the node vᵢ, kⱼ^{out} is an outdegree of the node vⱼ, and the iteration is performed until the PR value of each node reaches a stable value.

The above-mentioned calculation formulas for each type of node network indicator are merely illustrative. A person skilled in the art may also calculate respective node network indicators of the plurality of first sub-graphs and the plurality of first community structures by other calculation formulas, and the specific calculation process is not limited by the present application.

In this embodiment, S130 may include: calculating respective node network indicators of the plurality of first sub-graphs and the plurality of first community structures by a calculation formula corresponding to each node network indicator respectively, and saving the respective node network indicators. The calculation of node network indicators of the plurality of first community structures may only calculate node network indicators of the first layer of community in each first community structure, so that the node network indicators of each first community structure that need to be analyzed can be obtained quickly and effectively.

In the embodiments of the present application, by calculating respective node network indicators of the plurality of first sub-graphs and the plurality of first community structures, the importance of the insurance brokers is characterized from multiple dimensions, so that the role of the insurance brokers in the entire insurance marketing can be measured more comprehensively and accurately. At the same time, the subsequent analysis of the node network indicators can be facilitated, so as to mine a group of insurance brokers with higher activity and higher importance effectively.

According to an embodiment of the present application, S140 includes: sorting node network indicators of the first sub-graph according to a plurality of indicator categories, and determining a plurality of first nodes in which node network indicators of each of the plurality of indicator categories are top ranked; sorting node network indicators of at least one layer of community in the first community structure according to the plurality of indicator categories, and determining a plurality of second nodes in which node network indicators of each of the plurality of indicator categories are top ranked; determining a node in a union of the plurality of first nodes and the plurality of second nodes as a key node; and marketing the Internet insurance products based on the key node.

Specifically, the node network indicators of the first sub-graph may be sorted in descending order respectively according to a degree centrality, a closeness centrality, a betweenness centrality and a pagerank, to obtain a degree centrality arrangement order, a closeness centrality arrangement order, a betweenness centrality arrangement order and a pagerank arrangement order. The first n nodes in each arrangement order are selected respectively, a union of the first n nodes in each arrangement order are worked out to obtain a plurality of first nodes, and n may be 10.

In the embodiments of the present application, by sorting node network indicators of a first sub-graph according to indicator categories and determining a plurality of first nodes in which node network indicators of each indicator category are top ranked, broker nodes respectively with larger degree centrality, larger closeness centrality, larger betweenness centrality and larger pagerank are obtained in the plurality of first sub-graphs included in a broker social network. Of course, in each sub-graph, a intersection of the first n nodes in each arrangement order may also be obtained, so that broker nodes with larger degree centrality, larger closeness centrality, larger betweenness centrality and larger pagerank are obtained in the plurality of first sub-graphs included in the broker social network.

Similarly, the node network indicators of the first community structure may be sorted in descending order respectively according to a degree centrality, a closeness centrality, a betweenness centrality and a pagerank, to obtain a degree centrality arrangement order, a closeness centrality arrangement order, a betweenness centrality arrangement order and a pagerank arrangement order. The first n nodes in each arrangement order are selected respectively, a union of the first n nodes in each arrangement order are worked out to obtain a plurality of second nodes, and n may be 10.

In the embodiments of the present application, by sorting node network indicators of a first community structure according to indicator categories and determining a plurality of second nodes in which node network indicators of each indicator category are top ranked, broker nodes respectively with larger degree centrality, larger closeness centrality, larger betweenness centrality and larger pagerank are obtained in the plurality of first community structures. Of course, in each community structure, a intersection of the first n nodes in each arrangement order may also be obtained, so that broker nodes with larger degree centrality, larger closeness centrality, larger betweenness centrality and larger pagerank are obtained in the plurality of first community structures.

In this embodiment, by determining nodes in a union of a plurality of first nodes and a plurality of second nodes as key nodes, the selection range of the key nodes is expanded. Further, more brokers can be generated by using social relationships of these brokers as key nodes through the rebate stimulation, and thus the Internet insurance products can be marketed through more brokers.

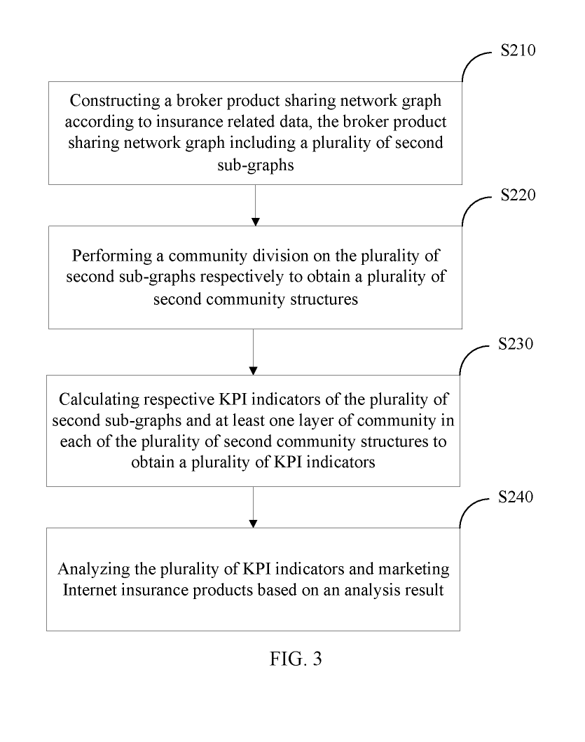

FIG. 3 is a schematic flowchart illustrating a marketing method for Internet insurance products according to another embodiment of the present application. The executive object of the method may be a variety of devices, such as a desktop computer, a personal computer, a mobile terminal and a server. As shown in FIG. 3, the method includes the following steps.

S210: constructing a broker product sharing network graph according to insurance related data, the broker product sharing network graph including a plurality of second sub-graphs.

Specifically, the insurance related data herein may include an insurance broker sharing product table, a product information table. Further, an insurance broker basic information table, insurance broker social data and the like may be included.

S220: performing a community division on the plurality of second sub-graphs respectively to obtain a plurality of second community structures.

Each second sub-graph corresponds to a second community structure, each second community structure may include at least one layer of community, and each layer of community may include at least one sub-community.

S230: calculating respective KPI indicators of the plurality of second sub-graphs and at least one layer of community in each of the plurality of second community structures to obtain a plurality of KPI indicators.

Specifically, the second sub-graph may include a plurality of nodes, and if there is an association between two nodes, the two nodes may be connected through a connection line. A node in the second sub-graph represents a broker or a customer, and an edge (i.e., the connection line) in the second sub-graph may represent a broker marketing an insurance product to a customer.

S240: analyzing the plurality of KPI indicators and marketing Internet insurance products based on an analysis result.

Specifically, by calculating respective KPI indicators of the plurality of second sub-graphs, a second sub-graph with a higher KPI indicator may be selected as a key sub-graph to market the insurance products, thereby improving the probability of success in insurance marketing.

Alternatively, when the second community structure includes multi-layer of communities, a key community may be selected by calculating the KPI indicator of each sub-community in a certain layer of community of the second community structure. For example, when the certain layer of community includes five sub-communities, respective KPI indicators of the five sub-communities may be calculated, and then a sub-community with a higher KPI indicator is selected as the key community for marketing the insurance products. Of course, the KPI indicator of each sub-community of each layer of community in the multi-layer of communities may also be calculated, and then the key community in each layer of community is selected.

The number of the key community may be one or more, and may be set specifically according to an actual requirement.

Since the broker product sharing network graph may show the relationship between a broker, a customer and an insurance product, the marketing preference of different products in different sub-communities may be depicted clearly by community division. Thus the insurance products can be marketed to network consumers according to the marketing preference of different products, and thereby meeting the purchase demands of the network consumers while improving the probability of success in insurance marketing.

The embodiments of the present application provide a marketing method for Internet insurance products. By constructing a broker product sharing network graph according to insurance related data and using a community division algorithm, a group of insurance brokers with higher activity and importance can be mined effectively, and the probability of success in Internet insurance marketing can be improved.

According to an embodiment of the present application, S210 may include: constructing the broker product sharing network graph by using a weakly connected graph according to the insurance related data.

Specifically, the concept of a weakly connected graph may be referred to the description in FIG. 1, and details are not described redundantly herein.

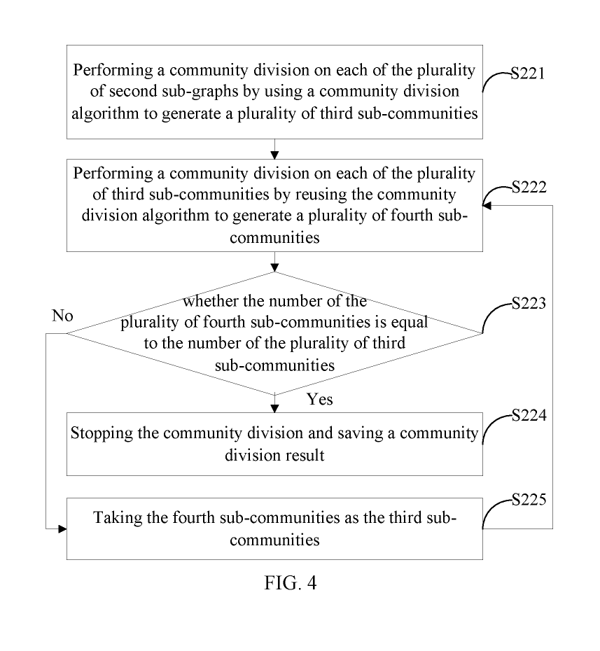

According to an embodiment of the present application, as shown in FIG. 4, S220 includes the following steps.

S221: performing a community division on each of the plurality of second sub-graphs by using a community division algorithm to generate a plurality of third sub-communities.

Specifically, a community division may be performed on each second sub-graph. The plurality of third sub-communities may be a first layer of community in the second community structure, that is, the first layer of community includes the plurality of third sub-communities.

S222: performing a community division on each of the plurality of third sub-communities by reusing the community division algorithm to generate a plurality of fourth sub-communities.

Specifically, the plurality of fourth sub-communities may be a second layer of community in the second community structure, that is, the second layer of community includes the plurality of fourth sub-communities. Each third sub-community may be divided into one or more fourth sub-communities, and fourth sub-communities corresponding to all third sub-communities may constitute the plurality of fourth sub-communities of the second layer of community.

Wherein, the number of nodes in the second sub-graph, the number of nodes of all third sub-communities in the first layer of community, and the number of nodes of all fourth sub-communities in the second layer of community are equal.

S223: determining whether the number of the plurality of fourth sub-communities is equal to the number of the plurality of third sub-communities, and if so, executing S224, and if not, executing S225.

S224: stopping the community division and saving a community division result.

S225: taking the fourth sub-communities as the third sub-communities, and continuing executing S222, and that is, continuing performing a community division on the plurality of fourth sub-communities.

Specifically, each fourth sub-community in the second layer of community may be divided continually until no more sub-communities can be divided.

In this embodiment, the community division algorithm may be a GN algorithm. The specific process of the algorithm may be referred to the description in FIG. 1, and details are not described redundantly herein.

According to an embodiment of the present application, each of a plurality of KPI indicators includes the number of brokers, times for sharing products, a distribution of hot-selling products and active time periods for sharing.

In this embodiment, taking a second sub-graph as an example, S230 may include: calculating the number of nodes of the second sub-graph and the sub-communities in the second community structure to obtain the number of brokers of the second sub-graph and the sub-communities respectively; calculating the number of edges in the second sub-graph and the sub-communities to obtain respective times for sharing products of the second sub-graph and the sub-communities; counting the sharing information of each product in the second sub-graph and the sub-communities to determine respective hot-selling products of the second sub-graph and the sub-communities; counting respective active time periods for sharing of the second sub-graph and the sub-communities according to the product sharing time; and saving the respective KPI indicators of the second sub-graph and the sub-communities.

The specific calculation process is not limited by the embodiments of the present application.

Specifically, the calculation of the KPI indicators of the plurality of second community structures may only calculate KPI indicators of the first layer of community in each second community structure, so that the KPI indicators of each second community structure are more representative and effective.

In the embodiments of the present application, by calculating the respective KPI indicators of the plurality of second sub-graphs and the plurality of second community structures, the product sharing behavior of the insurance brokers is characterized from multiple dimensions, and thus a guarantee basis is provided for subsequently increasing the probability of success in sharing products by brokers.

In this embodiment, S240 includes: determining a key sub-graph in the plurality of second sub-graphs and a key community in the plurality of second community structures based on the number of brokers and the times for sharing products, wherein each of the number of brokers in the key sub-graph and that in the key community exceeds a preset threshold, while each of times for sharing products exceeds a preset value; determining respective hot-selling products of the key sub-graph and the key community based on the distribution of hot-selling products to obtain a plurality of hot-selling products; and marketing a similar product of the plurality of hot-selling products in the key sub-graph and the key community respectively based on an active time period for sharing of each of the plurality of hot-selling products.

The preset number threshold of people and the preset number of times are not specifically limited by the embodiments of the present application.

In the embodiments of the present application, a key sub-graph in a plurality of second sub-graphs is determined according to KPI indicators of the plurality of second sub-graphs included in a broker sharing product network graph, the hot-selling products information in the key sub-graph is found according to a distribution of products in the key sub-graph, and thus a similar product is marketed among customers included in the key sub-graph. In addition, by according to an active time distribution of successful sharing of a hot-selling product in the key sub-graph, a similar product of the hot-selling product is pushed to corresponding customers in the key sub-graph in an active time by an insurance broker, so that the probability of success of the broker in selling the Internet insurance product can be increased. Further, by marketing the similar product of the hot-selling product in the key sub-graph and the key community, not only can conventional insurance products be marketed through the Internet, but also complex insurance products can be marketed through the Internet, which enables consumers to understand the nature of a product quickly and comprehensively, and thereby achieving the purpose of marketing complex insurance products through the Internet.

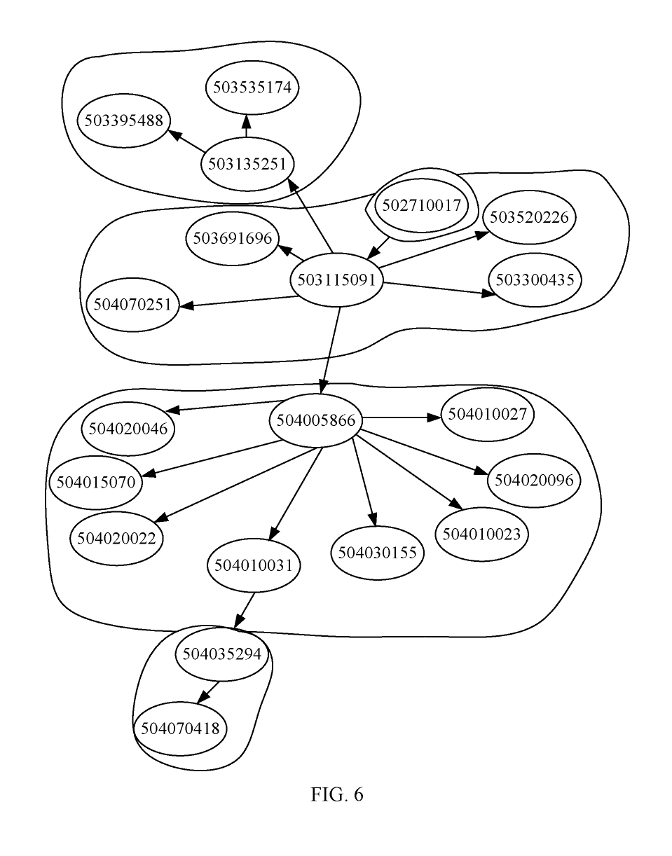

Illustratively, taking an analysis of an insurance agent platform as an example, a broker sharing network graph is constructed according to insurance related data of the insurance agent platform, and a community division result of the broker sharing product network graph obtained by using the community division algorithm described above in the embodiments of the present application may be referred to FIG. 6. FIG. 6 is a community division result of a broker product sharing network graph in an embodiment of the present application. In FIG. 6, the broker product sharing network graph is divided into a community structure with four sub-communities that are located in a first layer of community of the community structure. The community in which the node 503115091 is located is a sub-community of the first layer of community, and the sub-community includes a plurality of nodes.

In the embodiments of the present application, by establishing an insurance broker product sharing network graph and performing a community division, the marketing preferences of different products in different sub-graphs and sub-communities can be depicted clearly, so that insurance products can be marketed to network consumers according to the marketing preferences of different products, and thereby meeting the purchase demands of the network consumers.

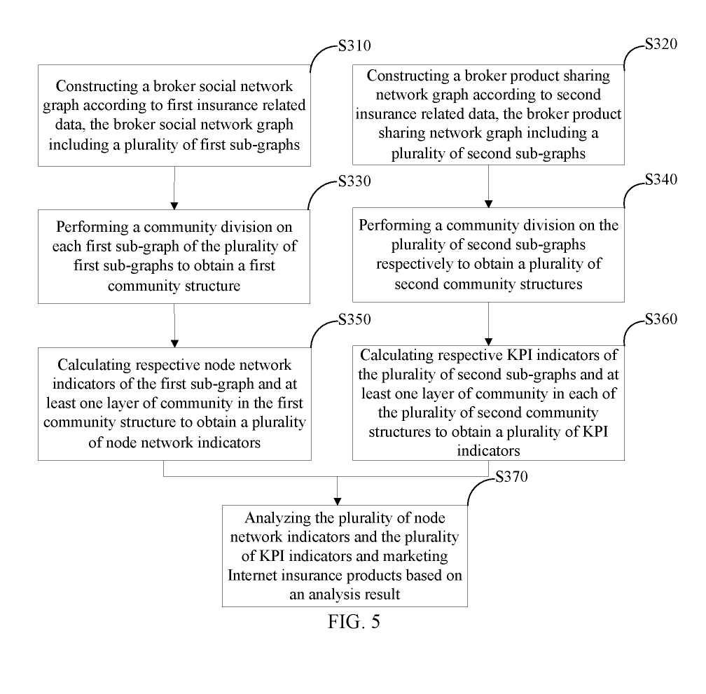

FIG. 5 is a schematic flowchart illustrating a marketing method for Internet insurance products according to another embodiment of the present application. The method is a combination of the method in FIG. 1 and the method in FIG. 3, and the similarities are not described specifically herein. As shown in FIG. 5, the method includes the following steps.

S310: constructing a broker social network graph according to first insurance related data, the broker social network graph including a plurality of first sub-graphs.

S320: constructing a broker product sharing network graph according to second insurance related data, the broker product sharing network graph including a plurality of second sub-graphs.

Specifically, the first insurance related data includes an insurance broker basic information table and insurance broker social data. The second insurance related data includes an insurance broker sharing product table and a product information table. Of course, the first insurance related data and the second insurance related data may be the same, and both include the insurance broker basic information table, the insurance broker social data, the insurance broker sharing product table, the product information table, and the like. S310 may be executed simultaneously with S320, or may be executed before or after S320.

S330: performing a community division on each first sub-graph of the plurality of first sub-graphs to obtain a first community structure.

S340: performing a community division on the plurality of second sub-graphs respectively to obtain a plurality of second community structures.

Specifically, a first community structure is obtained by performing a community division on each first sub-graph, and a second community structure is obtained by performing a community division on each second sub-graph. The specific process of community division may be referred to the descriptions in FIG. 2 and FIG. 4, and will not be described redundantly herein. S330 may be executed simultaneously with S340, or may be executed before or after S340.

S350: calculating respective node network indicators of the first sub-graph and at least one layer of community in the first community structure to obtain a plurality of node network indicators.

S360: calculating respective KPI indicators of the plurality of second sub-graphs and at least one layer of community in each of the plurality of second community structures to obtain a plurality of KPI indicators.

Specifically, the calculation of a node network indicator and the plurality of KPI indicators may be referred to the description in FIG. 1 and FIG. 3 respectively. S350 may be executed simultaneously with S360, or may be executed before or after S360.

S370: analyzing the plurality of node network indicators and the plurality of KPI indicators and marketing Internet insurance products based on an analysis result.

Specifically, key nodes (key brokers) with high activity and importance may be selected respectively from the first sub-graph and the sub-communities of the first sub-graph by node network indicators, and key sub-graphs and key communities may be selected from the plurality of second sub-graphs and the sub-communities of the second sub-graphs by KPI indicators. The selecting process of the key nodes may be referred to the description in FIG. 1, and the selection of the key sub-graphs and the key communities may be referred to the description in FIG. 3.

Since a key broker may appear in a key sub-graph or a key community, the key sub-graphs and the key communities may be combined with the key brokers to select key broker in the key sub-graphs or the key communities. By pushing hot-selling products or similar products of the hot-selling products to corresponding customers in the key sub-graphs through key brokers in the key sub-graphs or the key communities, the probability of success in broker selling Internet insurance products may be further increased while meeting the purchase demands of network consumers.

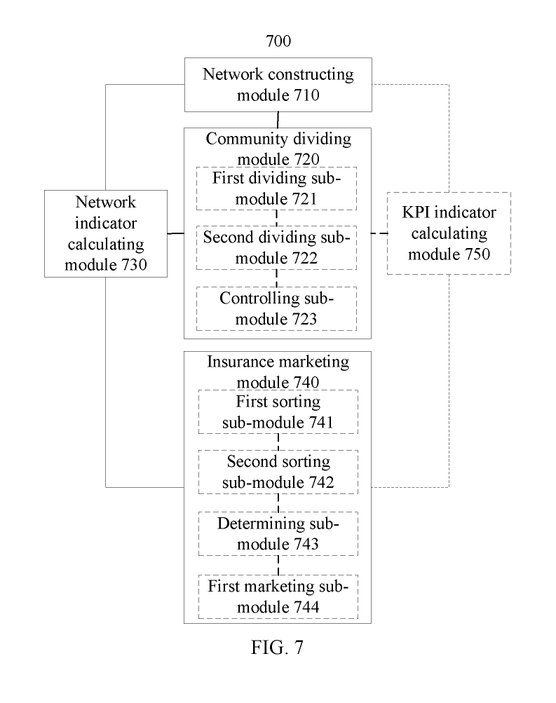

FIG. 7 is a schematic structural diagram illustrating a marketing system 700 for Internet insurance products according to an embodiment of the present application. As shown in FIG. 7, the marketing system 700 includes: a network constructing module 710, configured to construct a broker social network graph according to first insurance related data, the broker social network graph including a plurality of first sub-graphs; a community dividing module 720, configured to perform a community division on each first sub-graph of the plurality of first sub-graphs to obtain a first community structure; a network indicator calculating module 730, configured to calculate respective node network indicators of the first sub-graph and at least one layer of community in the first community structure to obtain a plurality of node network indicators; and an insurance marketing module 740, configured to analyze the plurality of node network indicators and market Internet insurance products based on an analysis result.

The embodiments of the present application provide a marketing system for Internet insurance products. By constructing a broker social network graph based on insurance related data and using a community division algorithm, a group of insurance brokers with higher activity and importance can be mined effectively, and the probability of success in Internet insurance marketing can be improved.

According to an embodiment of the present application, the network constructing module 710 is configured to construct the broker social network graph by using a weakly connected graph according to the first insurance related data. A node of the broker social network graph represents a broker, and an edge of the broker social network graph represents a broker social relationship.

According to an embodiment of the present application, the community dividing module 720 includes: a first dividing sub-module 721, configured to perform a community division on the first sub-graph by using a community division algorithm to generate a plurality of first sub-communities; a second dividing sub-module 722, configured to perform a community division on each of the plurality of first sub-communities by reusing the community division algorithm to generate a plurality of second sub-communities for the plurality of first sub-communities; and a controlling sub-module 723, configured to determine whether the number of the plurality of second sub-communities is equal to the number of the plurality of first sub-communities, and if so, stopping performing a community division, and if not, continuing performing a community division on the plurality of second sub-communities.

Preferably, the community division algorithm is a GN algorithm.

According to an embodiment of the present application, the insurance marketing module 740 includes: a first sorting sub-module 741, configured to sort node network indicators of the first sub-graph according to a plurality of indicator categories, and determine a plurality of first nodes in which node network indicators of each of the plurality of indicator categories are top ranked; a second sorting sub-module 742, configured to sort node network indicators of at least one layer of community in the first community structure according to the plurality of indicator categories, and determine a plurality of second nodes in which node network indicators of each of the plurality of indicator categories are top ranked; a determining sub-module 743, configured to determine a node in a union of the plurality of first nodes and the plurality of second nodes as a key node; and a first marketing sub-module 744, configured to market the Internet insurance products based on the key node. The plurality of indicator categories include degree centrality, closeness centrality, betweenness centrality, and pagerank.

According to an embodiment of the present application, the network constructing module 710 is further configured to construct a broker product sharing network graph according to second insurance related data, the broker product sharing network graph including a plurality of second sub-graphs. The community dividing module 720 is further configured to perform a community division on the plurality of second sub-graphs respectively to obtain a plurality of second community structures. The marketing system 700 further includes a KPI indicator calculating module 750, configured to calculate respective KPI indicators of the plurality of second sub-graphs and at least one layer of community in each of the plurality of second community structures to obtain a plurality of KPI indicators. The insurance marketing module 740 is configured to analyze the plurality of node network indicators and the plurality of KPI indicators, and market the Internet insurance products based on an analysis result.

Specifically, the specific working process of each module included in the marketing system 700 may be referred to the descriptions in FIG. 1 to FIG. 6, and will not be described redundantly herein to avoid repetition.

In this embodiment, by analyzing synthetically the plurality of node network indicators and the plurality of KPI indicators, the probability of success in brokers selling Internet insurance products can be further increased, while meeting the purchase demands of network consumers.

The embodiments of the present application provide a marketing system for Internet insurance products. In the marketing system, by establishing a broker social network graph and performing a community division, a group of insurance brokers with higher activity and higher importance can be mined effectively, so that the marketing of Internet insurance products can be carried out effectively, and the probability of success in Internet insurance marketing can be improved. In addition, by calculating a plurality of node network indicators of sub-graphs and communities contained in a broker social network graph, the importance of a broker can be characterized from multiple dimensions, so that the role of the broker in the overall insurance marketing can be measured more comprehensively and accurately. Further, by establishing an insurance broker product sharing network graph and performing a community division, the marketing preferences of different products in different sub-graphs and communities may be depicted clearly, so that the insurance products can be marketed to network consumers according to the marketing preferences of different products, and thereby meeting the purchase demands of the network consumers.

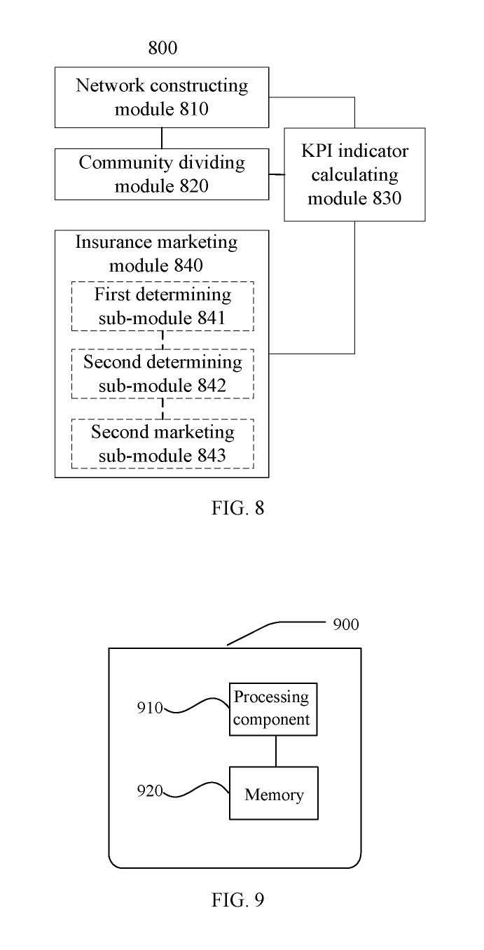

FIG. 8 is a schematic structural diagram illustrating a marketing system 800 for Internet insurance products according to another embodiment of the present application. As shown in FIG. 8, the marketing system 800 includes: a network constructing module 810, configured to construct a broker product sharing network graph according to insurance related data, the broker product sharing network graph including a plurality of second sub-graphs; a community dividing module 820, configured to perform a community division on the plurality of second sub-graphs respectively to obtain a plurality of second community structures; a KPI indicator calculating module 830, configured to calculate respective KPI indicators of the plurality of second sub-graphs and at least one layer of community in each of the plurality of second community structures to obtain a plurality of KPI indicators; and an insurance marketing module 840, configured to analyze the plurality of KPI indicators and market Internet insurance products based on an analysis result.

The embodiments of the present application provide a marketing system for Internet insurance products. By constructing a broker product sharing network graph according to insurance related data and using a community division algorithm, a group of insurance brokers with higher activity and importance can be mined effectively, and the probability of success in Internet insurance marketing can be improved.

According to an embodiment of the present application, the network constructing module 810 is configured to construct the broker product sharing network graph by using a weakly connected graph according to the insurance related data. A node of the broker product sharing network graph represents a broker or a customer, and an edge of the broker product sharing network graph represents a broker marketing an insurance product to a customer.

According to an embodiment of the present application, the community dividing module 820 includes: a first dividing sub-module, configured to perform a community division on each of the plurality of second sub-graphs by using a community division algorithm to generate a plurality of third sub-communities; a second dividing sub-module, configured to perform a community division on each of the plurality of third sub-communities by reusing the community division algorithm to generate a plurality of fourth sub-communities for the plurality of third sub-communities; and a controlling sub-module, configured to determine whether the number of the plurality of fourth sub-communities is equal to the number of the plurality of third sub-communities, and if so, stopping performing a community division, and if not, continuing performing a community division on the plurality of fourth sub-communities.

According to an embodiment of the present application, each of the plurality of KPI indicators includes the number of brokers, times for sharing products, a distribution of hot-selling products and active time periods for sharing. The insurance marketing module 840 includes: a first determining sub-module 841, configured to determine a key sub-graph in the plurality of second sub-graphs and a key community in the plurality of second community structures based on the number of brokers and the times for sharing products, wherein each of the number of brokers in the key sub-graph and that in the key community exceeds a preset threshold, while each of times for sharing products exceeds a preset value; a second determining sub-module 842, configured to determine respective hot-selling products of the key sub-graph and the key community based on the distribution of hot-selling products to obtain a plurality of hot-selling products; and a second marketing sub-module 843, configured to market a similar product of the plurality of hot-selling products in the key sub-graph and the key community respectively based on an active time period for sharing of each of the plurality of hot-selling products.

FIG. 9 is a block diagram illustrating a computer device 900 for marketing Internet insurance products according to an exemplary embodiment of the present application.

Referring to FIG. 9, the device 900 includes a processing component 910 that further includes one or more processors, and memory resources represented by a memory 920 for storing instructions executable by the processing component 910, such as an application program. The application program stored in the memory 920 may include one or more modules each corresponding to a set of instructions. Further, the processing component 910 is configured to execute the instructions to perform the above marketing method for Internet insurance products.

The device 900 may also include a power supply module configured to perform power management of the device 900, wired or wireless network interface(s) configured to connect the device 900 to a network, and an input/output (I/O) interface. The device 900 may operate based on an operating system stored in the memory 920, such as Windows Server™, Mac OS X™, Unix™, Linux™, FreeBSD™, or the like.

A non-temporary computer readable storage medium, when instructions in the storage medium are executed by a processor of the above device 900, cause the above device 900 to perform a marketing method for Internet insurance products including: constructing a broker social network graph according to first insurance related data, the broker social network graph including a plurality of first sub-graphs; performing a community division on each first sub-graph of the plurality of first sub-graphs to obtain a first community structure; calculating respective node network indicators of the first sub-graph and at least one layer of community in the first community structure to obtain a plurality of node network indicators; and analyzing the plurality of node network indicators and marketing Internet insurance products based on an analysis result.

Persons skilled in the art may realize that, units and algorithm steps of examples described in combination with the embodiments disclosed here can be implemented by electronic hardware, computer software, or the combination of the two. Whether the functions are executed by hardware or software depends on particular applications and design constraint conditions of the technical solutions. Persons skilled in the art may use different methods to implement the described functions for each particular application, but it should not be considered that the implementation goes beyond the scope of the present disclosure.

It can be clearly understood by persons skilled in the art that, for the purpose of convenient and brief description, for a detailed working process of the foregoing system, device and unit, reference may be made to the corresponding process in the method embodiments, and the details are not to be described here again.

In several embodiments provided in the present application, it should be understood that the disclosed system, device, and method may be implemented in other ways. For example, the described device embodiments are merely exemplary. For example, the unit division is merely logical functional division and may be other division in actual implementation. For example, multiple units or components may be combined or integrated into another system, or some features may be ignored or not performed. Furthermore, the shown or discussed coupling or direct coupling or communication connection may be accomplished through indirect coupling or communication connection between some interfaces, devices or units, or may be electrical, mechanical, or in other forms.

Units described as separate components may be or may not be physically separated. Components shown as units may be or may not be physical units, that is, may be integrated or may be distributed to a plurality of network units. Some or all of the units may be selected to achieve the objective of the solution of the embodiment according to actual demands.

In addition, the functional units in the embodiments of the present disclosure may either be integrated in a processing module, or each be a separate physical unit; alternatively, two or more of the units are integrated in one unit.

If implemented in the form of software functional units and sold or used as an independent product, the integrated units may also be stored in a computer readable storage medium. Based on such understanding, the technical solution of the present disclosure or the part that makes contributions to the prior art, or a part of the technical solution may be substantially embodied in the form of a software product. The computer software product is stored in a storage medium, and contains several instructions to instruct computer equipment (such as, a personal computer, a server, or network equipment) to perform all or a part of steps of the method described in the embodiments of the present disclosure. The storage medium includes various media capable of storing program codes, such as, a USB flash drive, a mobile hard disk, a Read-Only Memory (ROM), a Random Access Memory (RAM), a magnetic disk or an optical disk.

It should be noted that in the description of the present application, the terms “first”, “second”, “third” and the like are only used for the purpose of description, and cannot be understood to indicate or imply relative importance. Further, in the description of the present application, the meaning of “a plurality” is two or more unless otherwise specified.

The above are only the preferred embodiments of the present application and are not configured to limit the scope of the present application. Any modifications, equivalent substitutions, improvements and so on made within the spirit and principle of the present application should be included within the scope of the present application.

What is claimed is:

1. A marketing method for Internet insurance products, comprising:
constructing a broker social network graph according to first insurance related data, the broker social network graph comprising a plurality of first sub-graphs;
performing a community division on each first sub-graph of the plurality of first sub-graphs to obtain a first community structure;
calculating respective node network indicators of the first sub-graph and at least one layer of community in the first community structure to obtain a plurality of node network indicators; and
analyzing the plurality of node network indicators and marketing Internet insurance products based on an analysis result.

2. The method according to claim 1, wherein the constructing a broker social network graph according to first insurance related data comprises:
constructing the broker social network graph by using a weakly connected graph according to the first insurance related data,
wherein a node of the broker social network graph represents a broker, and an edge of the broker social network graph represents a broker social relationship.

3. The method according to claim 1, wherein the performing a community division on each first sub-graph of the plurality of first sub-graphs comprises:
performing a community division on the first sub-graph by using a community division algorithm to generate a plurality of first sub-communities;
performing a community division on each of the plurality of first sub-communities by reusing the community division algorithm to generate a plurality of second sub-communities for the plurality of first sub-communities; and
determining whether the number of the plurality of second sub-communities is equal to the number of the plurality of first sub-communities, and if so, stopping performing a community division, and if not, continuing performing a community division on the plurality of second sub-communities.

4. The method according to claim 3, wherein the community division algorithm is a GN algorithm.

5. The method according to claim 1, wherein the analyzing the plurality of node network indicators and marketing Internet insurance products based on an analysis result comprises:
sorting node network indicators of the first sub-graph according to a plurality of indicator categories, and determining a plurality of first nodes in which node network indicators of each of the plurality of indicator categories are top ranked;
sorting node network indicators of at least one layer of community in the first community structure according to the plurality of indicator categories, and determining a plurality of second nodes in which node network indicators of each of the plurality of indicator categories are top ranked;
determining a node in a union of the plurality of first nodes and the plurality of second nodes as a key node; and
marketing the Internet insurance products based on the key node;
wherein the plurality of indicator categories comprise a degree centrality, a closeness centrality, a betweenness centrality and a pagerank.

6. The method according to claim 1, further comprising:
constructing a broker product sharing network graph according to second insurance related data, the broker product sharing network graph comprising a plurality of second sub-graphs;
performing a community division on the plurality of second sub-graphs respectively to obtain a plurality of second community structures; and
calculating respective KPI indicators of the plurality of second sub-graphs and at least one layer of community in each of the plurality of second community structures to obtain a plurality of KPI indicators,
wherein the analyzing the plurality of node network indicators and marketing Internet insurance products based on an analysis result comprises;
analyzing the plurality of node network indicators and the plurality of KPI indicators, and marketing the Internet insurance products based on an analysis result.

7. A marketing method for Internet insurance products, comprising:
constructing a broker product sharing network graph according to insurance related data, the broker product sharing network graph comprising a plurality of second sub-graphs;
performing a community division on the plurality of second sub-graphs respectively to obtain a plurality of second community structures;
calculating respective KPI indicators of the plurality of second sub-graphs and at least one layer of community in each of the plurality of second community structures to obtain a plurality of KPI indicators; and
analyzing the plurality of KPI indicators and marketing Internet insurance products based on an analysis result.

8. The method according to claim 7, wherein the constructing a broker product sharing network graph according to insurance related data comprises:
constructing the broker product sharing network graph by using a weakly connected graph according to the insurance related data;
wherein a node of the broker product sharing network graph represents a broker or a customer, and an edge of the broker product sharing network graph represents a broker marketing an insurance product to a customer.

9. The method according to claim 7, wherein the performing a community division on the plurality of second sub-graphs respectively comprises:
performing a community division on each of the plurality of second sub-graphs by using a community division algorithm to generate a plurality of third sub-communities;
performing a community division on each of the plurality of third sub-communities by reusing the community division algorithm to generate a plurality of fourth sub-communities for the plurality of third sub-communities; and
determining whether the number of the plurality of fourth sub-communities is equal to the number of the plurality of third sub-communities, and if so, stopping performing a community division, and if not, continuing performing a community division on the plurality of fourth sub-communities.

10. The method according to claim 7, wherein each of the plurality of KPI indicators comprises the number of brokers, times for sharing products, a distribution of hot-selling products and active time periods for sharing, and the analyzing the plurality of KPI indicators and marketing Internet insurance products based on an analysis result comprises:
determining a key sub-graph in the plurality of second sub-graphs and a key community in the plurality of second community structures based on the number of brokers and the times for sharing products, wherein each of the number of brokers in the key sub-graph and that in the key community exceeds a preset threshold, while each of times for sharing products exceeds a preset value;
determining respective hot-selling products of the key sub-graph and the key community based on the distribution of hot-selling products to obtain a plurality of hot-selling products; and
marketing a similar product of the plurality of hot-selling products in the key sub-graph and the key community respectively based on an active time period for sharing of each of the plurality of hot-selling products.

11. A marketing system for Internet insurance products, comprising:
a processor; and
a memory for storing instructions executable by the processor;
wherein the processor is configured to:
construct a broker social network graph according to first insurance related data, the broker social network graph comprising a plurality of first sub-graphs;
perform a community division on each first sub-graph of the plurality of first sub-graphs to obtain a first community structure;
calculate respective node network indicators of the first sub-graph and at least one layer of community in the first community structure to obtain a plurality of node network indicators; and
analyze the plurality of node network indicators and market Internet insurance products based on an analysis result.

12. The marketing system according to claim 11, wherein the processor is configured to construct the broker social network graph by using a weakly connected graph according to the first insurance related data, wherein a node of the broker social network graph represents a broker, and an edge of the broker social network graph represents a broker social relationship.

13. The marketing system according to claim 11, wherein the processor is configured to:
perform a community division on the first sub-graph by using a community division algorithm to generate a plurality of first sub-communities;
perform a community division on each of the plurality of first sub-communities by reusing the community division algorithm to generate a plurality of second sub-communities for the plurality of first sub-communities; and
determine whether the number of the plurality of second sub-communities is equal to the number of the plurality of first sub-communities, and if so, stopping performing a community division, and if not, continuing performing a community division on the plurality of second sub-communities.

14. The marketing system according to claim 11, wherein the processor is configured to:
sort node network indicators of the first sub-graph according to a plurality of indicator categories, and determine a plurality of first nodes in which node network indicators of each of the plurality of indicator categories are top ranked;
sort node network indicators of at least one layer of community in the first community structure according to the plurality of indicator categories, and determine a plurality of second nodes in which node network indicators of each of the plurality of indicator categories are top ranked;
determine a node in a union of the plurality of first nodes and the plurality of second nodes as a key node; and
market the Internet insurance products based on the key node;
wherein the plurality of indicator categories comprise a degree centrality, a closeness centrality, a betweenness centrality and a pagerank.

15. The marketing system according to claim 11, wherein the processor is further configured to: construct a broker product sharing network graph according to second insurance related data, the broker product sharing network graph comprising a plurality of second sub-graphs; perform a community division on the plurality of second sub-graphs respectively to obtain a plurality of second community structures; and calculate respective KPI indicators of the plurality of second sub-graphs and at least one layer of community in each of the plurality of second community structures to obtain a plurality of KPI indicators,
wherein the processor is configured to analyze the plurality of node network indicators and the plurality of KPI indicators, and market the Internet insurance products based on an analysis result.

16. A marketing system for Internet insurance products, comprising:
a processor; and
a memory for storing instructions executable by the processor;
wherein the processor is configured to:
construct a broker product sharing network graph according to insurance related data, the broker product sharing network graph comprising a plurality of second sub-graphs;
perform a community division on the plurality of second sub-graphs respectively to obtain a plurality of second community structures;
calculate respective KPI indicators of the plurality of second sub-graphs and at least one layer of community in each of the plurality of second community structures to obtain a plurality of KPI indicators; and
analyze the plurality of KPI indicators and market Internet insurance products based on an analysis result.

17. The marketing system according to claim 16, wherein the processor is configured to construct the broker product sharing network graph by using a weakly connected graph according to the insurance related data, wherein a node of the broker product sharing network graph represents a broker or a customer, and an edge of the broker product sharing network graph represents a broker marketing an insurance product to a customer.

18. The marketing system according to claim 16, wherein the processor is configured to:
perform a community division on each of the plurality of second sub-graphs by using a community division algorithm to generate a plurality of third sub-communities;
perform a community division on each of the plurality of third sub-communities by reusing the community division algorithm to generate a plurality of fourth sub-communities for the plurality of third sub-communities; and
determine whether the number of the plurality of fourth sub-communities is equal to the number of the plurality of third sub-communities, and if so, stopping performing a community division, and if not, continuing performing a community division on the plurality of fourth sub-communities.

19. The marketing system according to claim 16, wherein each of the plurality of KPI indicators comprises the number of brokers, times for sharing products, a distribution of hot-selling products and active time periods for sharing, and the processor is configured to:
determine a key sub-graph in the plurality of second sub-graphs and a key community in the plurality of second community structures based on the number of brokers and the times for sharing products, wherein each of the number of brokers in the key sub-graph and that in the key community exceeds a preset threshold, while each of times for sharing products exceeds a preset value;
determine respective hot-selling products of the key sub-graph and the key community based on the distribution of hot-selling products to obtain a plurality of hot-selling products; and
market a similar product of the plurality of hot-selling products in the key sub-graph and the key community respectively based on an active time period for sharing of each of the plurality of hot-selling products.
